(19) United States
(12) Patent Application Publication
(10) Pub. No.: US 2006/0012586 A1
(43) Pub. Date: Jan. 19, 2006

(54) Display device and method for adjusting display device settings based on a predetermined code

(76) Inventors: David Ochs, Corvallis, OR (US); Bruce A. Stephens, Corvallis, OR (US)

Correspondence Address: HEWLETT-PACKARD COMPANY;Intellectual Property Administration, P.O. Box 272400, Fort Collins, CO, 80527-2400, US

(21) Appl. No.: 10/892,407

(22) Filed: Jul. 15, 2004

(51) Int. Cl. G09G 5/00

(52) U.S. Cl. 345/204

(57) ABSTRACT

A display device includes a user input device for allowing a user to input a predetermined code, and a processor programmed to automatically adjust one or more settings of the display device based on the predetermined code.

### BACKGROUND

Display devices are widely used for entertainment, information sharing and other applications. Display devices include projectors that project an image, such as a slide show or motion picture, onto a projection surface. Another type of display device is a television set or video monitor that can also display still or motion pictures.

A display device typically has many settings that control the way an input video signal is displayed. These settings include tint, contrast, color temperature, image offsets, gamma adjustments and many other settings.

While these settings allow a user to control the display device, it may be difficult for the average user to figure out how to access and adjust the various settings available. Moreover, there will be a set of optimal settings for a given display device under a particular set of circumstances based on such factors as the conditions in which the display is being viewed, the source of the input video signal and the content of the input video signal.

Unfortunately, it takes time, knowledge and experience for a user to change all of the available settings to achieve the optimal settings for a particular circumstance. Then, if anything changes, such as the level of ambient light or the content or source of the video signal being displayed, it may be necessary to change the settings to again achieve an optimal display image.

Most users do not have the time or the patience to learn how to adjust the various interrelated settings to produce an optimal display image. Rather, most users simply accept a less than optimal display image.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates a system according to one embodiment described herein in which a user can easily optimize the settings of a display device by entering a predetermined code specific to the current operating circumstances of the display device.

FIG. 2 illustrates another specific embodiment of a display device for which a user can easily optimize the settings of the display device by entering a predetermined code specific to the current operating circumstances of the display device.

FIG. 3 illustrates still another specific embodiment of a display device for which a user can easily optimize the settings of the display device by entering a predetermined code specific to the current operating circumstances of the display device.

FIG. 4 is a flowchart illustrating a method of operating the display device systems illustrated in FIGS. 1-3.

FIG. 5 is a flowchart illustrating a method of distributing predetermined codes for optimizing the settings of display devices such as those illustrated in FIGS. 1-3.

Throughout the drawings, identical reference numbers designate similar, but not necessarily identical, elements.

### DETAILED DESCRIPTION

As described in this specification, the user of a display device can obtain one or more predetermined codes that correspond to the settings needed to adjust the settings of the display device to optimize the image of the display device. Each code is specific to particular operating circumstances of the display device, such as ambient viewing conditions; video signal source, including video signal type; and video signal content. The appropriate code is then input to the display device to automatically optimize the image of the display device for the corresponding current circumstances.

As used herein and in the appended claims, the term “display device” will be understood to refer broadly to any device that displays an image. Examples of a display device include, but are not limited to, a projector, a television, a video monitor, a computer monitor, a liquid crystal display (LCD), a cathode ray tube (CRT), a plasma display, a flat panel display, etc. The “image” displayed may be a still picture, a slide show or series of still pictures or a movie, television program or other motion picture.

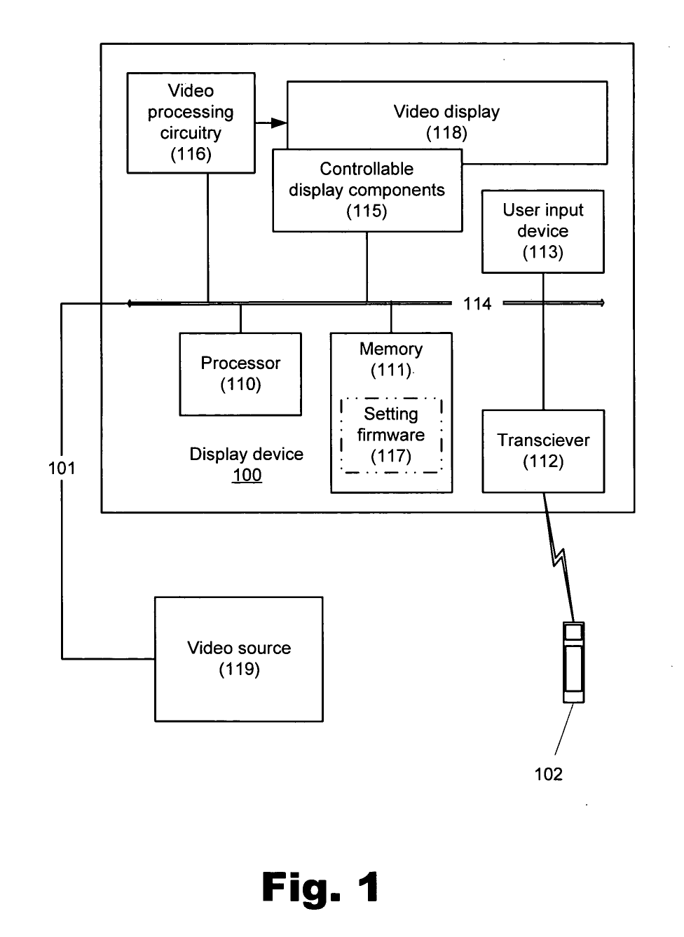

Referring now to the drawings, FIG. 1 illustrates a system according to one embodiment described herein in which a user can easily optimize the settings of a display device by entering a predetermined code specific to the current operating circumstances of the display device. As shown in FIG. 1, the display device (100) receives an input video signal (101) from a video source (119).

As noted above, the display device (100) may be, for example, a projector, a television set, a video monitor, etc. The video source (119) may be any device that outputs a video or image signal (101) to the display device. For example, the video source (119) may be, but is not limited to, a computer or laptop, a set-top box, a satellite or terrestrial antenna, a digital or video camera, a Digital Video Disc (DVD) player, a Video Cassette Recorder (VCR), a Personal Video Recorder (PVR), video game system, etc.

The video signal (101) output by the video source (119) is received in the display device (100). The video signal (101) is typically processed through video processing circuitry (116) and then output to the video display (118). The video display (118) then generates the image or images that can be viewed by a human user. In the example of a projector, the video display (118) would include a projection lamp, electronic image element and projection optics. In the example of a television or video monitor, the video display (118) would include a screen and display driver or a cathode ray tube and electron gun.

In any case, the video display (118) will also include controllable display components (115). These are the components (115) for which setting can be adjusted to optimize the image produced by the display device (100). As noted above, the settings needed to optimize the image can vary depending on the ambient conditions, such as ambient light level, the type of video source used including the incoming video signal type, and the content of the video signal.

Consequently, the user can typically access the settings for the controllable display components (115) and adjust those settings to optimize the resulting image of the display device (100). This is done by using a user interface, such as a user input device (113) or a remote control unit (102), to enter the desired settings. A processor (110) then adjusts the settings of the controllable display components (115) based on the user input. A data bus (114) allows the various internal components of the display device (100) to communicate with one another.

The user input device (113) may be, for example, a keypad such as a numeric or alphanumeric keypad. In another example, the user input device can be a bar code reader or similar device that reads a code to be input to the display device to optimize image settings. The user input device (113) can be any device for receiving user input.

The remote control unit (102) may also include a keypad, such as a numeric or alphanumeric keypad, or other user input device. User input entered on the remote control unit (102) is wirelessly transmitted to a transceiver (112). The transceiver (112) is connected to the data bus (114) so that user input from the remote control unit (102) can be communicated to the processor (110). The processor (110) executes firmware stored in a memory unit (111) of the display device (100).

As noted above, it takes time, knowledge and experience for a user to access and change the available settings of the controllable display components (115) to achieve the optimal display device settings for a particular circumstance. Then, if anything changes, such as the level of ambient light or the content or source (119) of the video signal (101) being displayed, it may be necessary to again change the settings to regain an optimal display image. Most users do not have the time or the patience to learn how to adjust the various interrelated settings to produce an optimal display image, but simply accept a less than optimal display image.

To assist the user, according to the principles described herein, predetermined codes are developed that correspond to the optimal settings for the controllable display components (115) under different circumstances. The different circumstances are based, for example, on the ambient conditions, such as the ambient light level or light source, the source (119) of the video signal (101), the type of video signal (e.g., Composite, S-Video, Component, etc.), and the content of the video signal (101).

The predetermined codes may be numeric or alphanumeric strings that specify some or all of the settings for the controllable display components and the optimal value for each specified setting under a particular set of circumstances. For example, the predetermined codes may include a series of alphabetic abbreviations or identifiers for particular settings that can be adjusted, each followed by a number indicating the optimal value for that setting. Alternatively, the values for particular settings could be placed in a particular order so that the location of the value in the code string indicates which setting is to be adjusted to that value. As will be appreciated by those skilled in the art, there will be a wide variety of ways in which the predetermined code can convey values for particular corresponding settings.

The predetermined codes can be developed by the manufacturer of the display device (100). Alternatively, the predetermined codes may be developed by other organizations, businesses or user groups interested in a particular display device.

Each predetermined code provides the optimal settings for the display device under a particular set of circumstances. For example, there may be a code that corresponds to each of the following: “movie in a dark room,” “movie in a well-lit room,” “movie in a room with fluorescent lighting,” “slide show in a dark room,” “slide show in a room with fluorescent lighting,” “output from a Nintendo® GameCube®,” “output from a Sony® Playstation2®,” “output from a DVD player,” “sports,” “cartoons,” etc. The predetermined codes can also be for very specific video inputs, such as for a particular movie.

The predetermined codes can take into account, for example, (1) ambient conditions, such as ambient light source or light level, (2) the source of the video signal, including the incoming video signal type, such as Composite, S-Video, Component, and digital signals on “Digital Video Input” (DVI) and M1 connectors, etc. and (3) the content of the video signal. Two or more predetermined codes can be used together to specify the circumstances in which the display device (100) is operating.

Once the user has identified the predetermined code appropriate to the operating circumstances of the display device (100), that code is simply entered into the display device (100). This may be done using either the user input device (113) on the display device (100), the remote control unit (102) and transceiver (112), or by any other means.

The input code is received by the processor (110). The processor (110) will then access setting firmware (117) stored in the memory (111) of the display device (100). The setting firmware (117) will translate the input code into particular corresponding adjustments to the settings of the controllable display components (115). These adjustments are then made by the processor (110) controlling the components (115) through the bus (114). As a result, the image displayed by the display device (100) is optimized for the circumstances.

The memory unit (111) may be a read-only memory unit or may allow the display device (100) to store data received. If the memory unit (111) can store data received, predetermined codes that have been input can be stored in the memory unit (111) for subsequent use. For example, if the user has input a code corresponding to a “movie in a dark room from a DVD player,” that code can be accessed in memory (111) and executed to optimize the display device (100) for the movie the user desires to view.

The user input device (113) or the remote control unit (102) can be used to access the codes previously stored in the memory (111), select a desired code and implement that code to change the settings of the display device (100). The firmware (117) can include a text description of the conditions or circumstances to which the predetermined codes correspond. These text descriptions can be displayed on the display (118) as the user operates the user input device (113) or remote control unit (102) to assist the user in selecting the stored code needed in a particular instance.

Consequently, using the system described herein, the user does not need to know what settings to adjust or how to adjust those settings to obtain an optimal display. Rather, the user merely needs to obtain the appropriate code and input that code into the display device. The methods by which the user may obtain the appropriate code will be described in more detail below.

Moreover, optimal settings can be determined for very specific circumstances. However, only the users who need or desire the settings for a particular circumstance will acquire and input the corresponding code. Thus, the manufacture and operation of the device are not complicated by the need to provide an exhaustive list of all possible circumstances that dictate different device settings. Additionally, as new video sources or other developments become available, corresponding optimization codes can be developed and provided even though the display device is already in service.

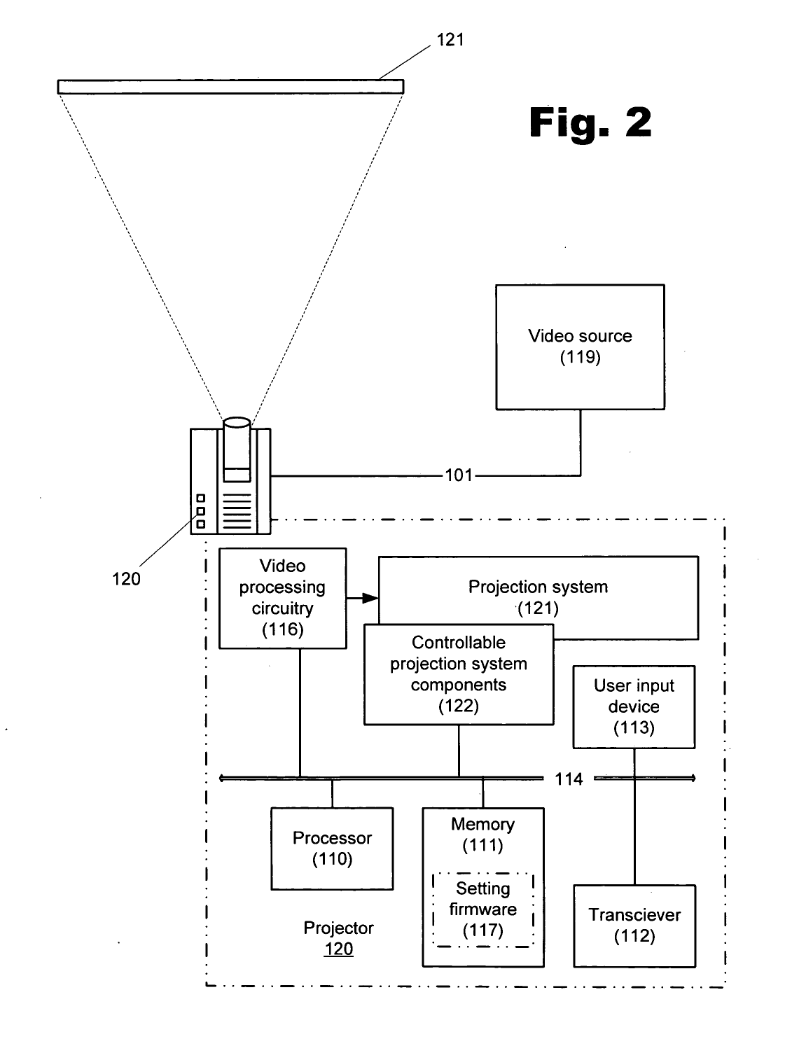

FIG. 2 illustrates another specific embodiment of a display device for which a user can easily optimize the settings of the display device by entering a predetermined code specific to the current operating circumstances of the display device. As illustrated in FIG. 2, the display device may be a projector (120) that projects an image onto a projection surface (121). The projection surface (121) may be a screen, a blank wall or other surface on which an image can be projected and viewed.

The video source (119) can be, for example, a laptop computer with the projector (120) being used to give a presentation. Alternatively, the projector (120) may be used in a home entertainment system. In which case, the video source (119) may be, for example, a set-top box, terrestrial or satellite antenna, DVD player, VCR, PVR, etc.

The projector (120) includes a projection system (121) that includes controllable projection system components (122). These components (122) have settings that can be adjusted to optimize the output of the projector (120).

Similar to the generic display device described above, the projector (120) includes a processor (110), a memory unit (111) including setting firmware (117), a user input device (113) and/or a transceiver (112) for interacting with a remote control unit. A redundant explanation of these components and their operation will be omitted.

As described herein, for any given set of operating circumstances, a user can identify a predetermined code that will optimize the settings of the projector's controllable projection system components (122). Once the user has identified the predetermined code appropriate to the operating circumstances of the projector (120), that code is simply entered into the projector (120). This may be done using either the user input device (113) or a remote control unit in communication with the transceiver (112).

The input code is received by the processor (110). The processor (110) will then access setting firmware (117) stored in the memory (111) of the projector (120). The setting firmware (117) will translate the input code into particular corresponding adjustments to the settings of the controllable projection system components (122). These adjustments are then made by the processor (110) controlling the components (122) through the bus (114). As a result, the image displayed by the projector (120) is optimized for the circumstances.

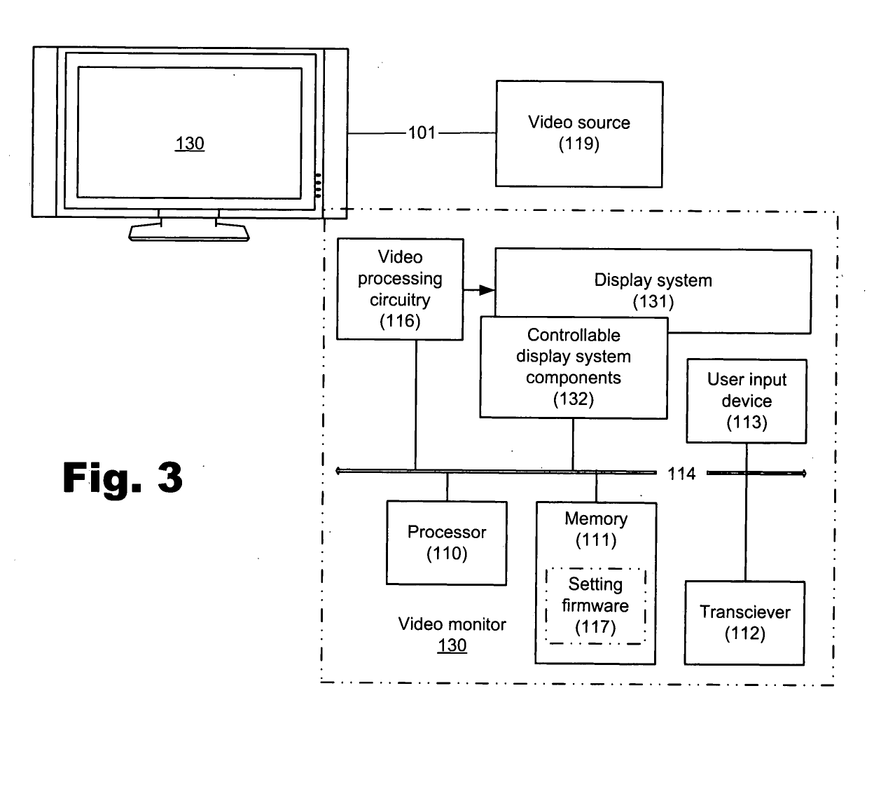

FIG. 3 illustrates still another specific embodiment of a display device for which a user can easily optimize the settings of the display device by entering a predetermined code specific to the current operating circumstances of the display device. As illustrated in FIG. 3, the display device may be a video monitor (130), such as a television or a computer monitor. The video source (119) can be, for example, a computer, a set-top box, terrestrial or satellite antenna, DVD player, VCR, PVR, etc.

The video monitor (130) includes a display system (131) that may include, for example, a CRT, LCD, plasma screen or the like. The display system (131) also includes controllable display system components (132). These components (132) have settings that can be adjusted to optimize the image on the display system (131).

Similar to the generic display device described above, the video monitor (130) includes a processor (110), a memory unit (111) including setting firmware (117), a user input device (113) and/or a transceiver (112) for interacting with a remote control unit. A redundant explanation of these components and their operation will be omitted.

As described herein, for any given set of operating circumstances, a user can identify a predetermined code that will optimize the settings of the monitor's controllable display system components (132). Once the user has identified the predetermined code appropriate to the operating circumstances of the video monitor (130), that code is simply entered into the video monitor (130). This may be done using either the user input device (113) or a remote control unit in communication with the transceiver (112).

The input code is received by the processor (110). The processor (110) will then access setting firmware (117) stored in the memory (111) of the video monitor (130). The setting firmware (117) will translate the input code into particular corresponding adjustments to the settings of the controllable display system components (132). These adjustments are then made by the processor (110) controlling the components (132) through the bus (114). As a result, the image displayed by the video monitor (130) is optimized for the circumstances.

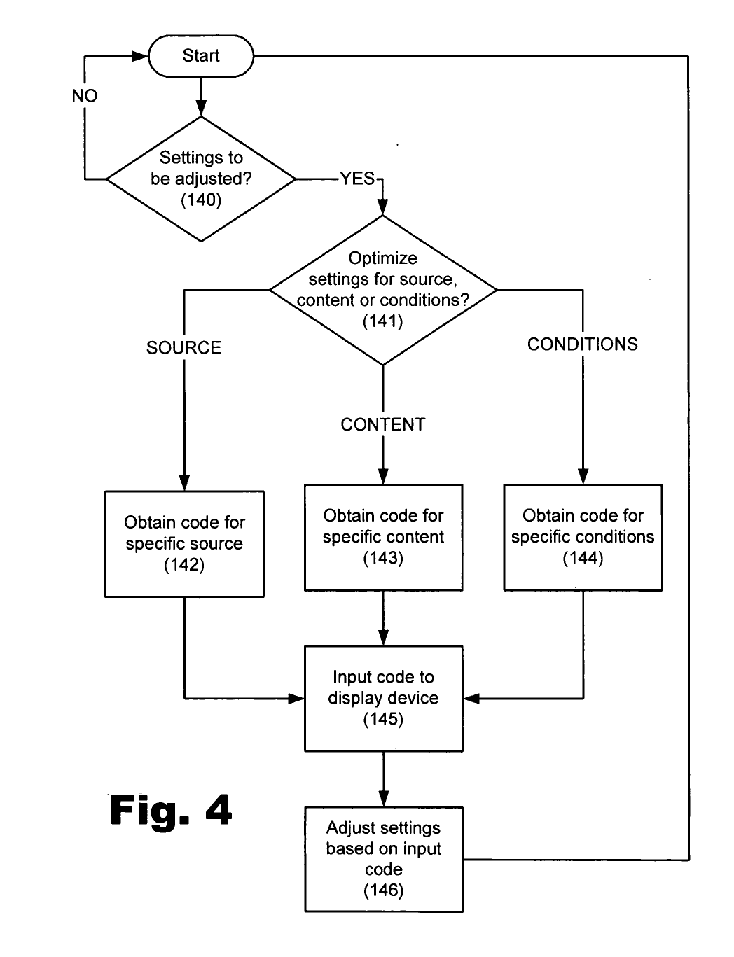

FIG. 4 is a flowchart illustrating a method of operating the display device systems illustrated in FIGS. 1-3. As shown in FIG. 4, the user may first make a determination as to whether the image from the display device is satisfactory or should be improved. In other words, do adjustments need to be made to the settings of the display device (determination 140). This determination may be made each time conditions change, for example, a new video source is selected, ambient lighting conditions change, etc.

Next, a determination may be made as to whether the settings of the display device need to be adjusted to account for a particular video source, ambient conditions or video program content (determination 141). It may be the case that the settings need to be adjusted for one, two or all three of these factors.

If the display device settings need to be adjusted, at least in part, to account for a particular video signal source, the user the obtains a predetermined code for the specific video source being employed (step 142). In this instance, video source includes consideration of both the device used as the source of the video signal and the type of video signal that is incoming, e.g., Composite, S-video, Component, etc. If the display device settings need to be adjusted, at least in part, to account for ambient conditions, the user then obtains a predetermined code corresponding to the ambient conditions in which the display device is operating (step 144). Lastly, if the display device settings need to be adjusted, at least in part, to account for the content of the video signal source, for example, sports as opposed to cartoons as opposed to a movie, the user the obtains a predetermined code for the specific content of the video signal (step 143).

The code or codes obtained are then input into the display device (step 145). As indicated above, this may be done with any user input device on, connected to or in communication with the display device. For example, the code may be input using a keypad on the display device. The code may be input using a remote control unit that is communicating with the display device. The code may be input into a computer or other device that is connected to or in communication with the display device.

The display device will receive the code and interpret the code as a command to change one or more device settings and a specification of the adjustment to be made to each setting. The display device will the automatically adjust the device settings in accordance with the instructions embodied in the code (step 146).

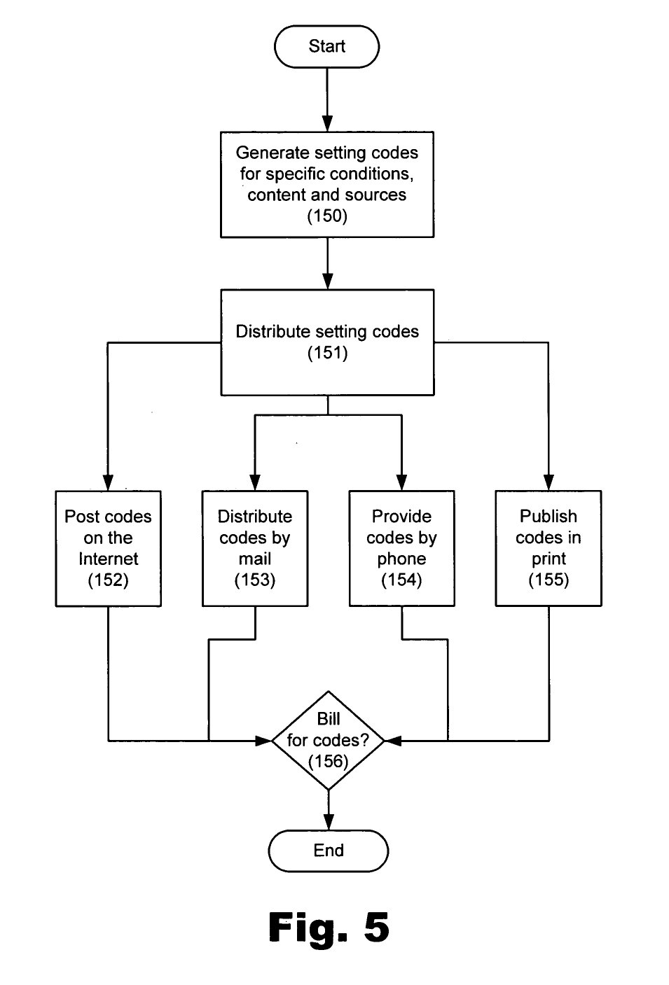

FIG. 5 is a flowchart illustrating a method of distributing predetermined codes for optimizing the settings of display devices such as those illustrated in FIGS. 1-3. As shown in FIG. 5, predetermined codes are generated that specify the optimal settings for a display device under a given set of operating circumstances (step 150). As has been described above, the codes can account for ambient conditions, such as ambient light level, video signal source, video signal type, video signal content. The codes can also take into account any other conditions or circumstances for which a change in device settings will produce an improved image quality in the displayed image.

The predetermined codes may be numeric or alphanumeric strings that specify some or all of the settings for the controllable display components and the optimal value for each specified setting under a particular set of circumstances. For example, the predetermined codes may include a series of alphabetic abbreviations or identifiers for particular settings that can be adjusted, each followed by a number indicating the optimal value for that setting. The predetermined codes may be generated by the manufacturer of the display device, by some other business organization, by a user group interested in that particular display device, by private individuals, etc.

Once the codes are generated, they are made available to users of the display device (step 151). As indicated, the user will only need to obtain those codes that pertain to his or her use of the display device.

The codes can be distributed by any means. For example, the codes can be posted on the Internet (step 152) and downloaded by interested users. The codes can also be distributed by mail or email, for example, to registered purchasers of the display device (step 153). The codes can also be distributed by phone. For example, the user may phone a service center to obtain the code or codes desired based on his or her use of the display device (step 154). Lastly, the codes can be published in print, for example, in magazines the cover the display device or related electronics or in a user's manual for the display device (step 155).

In some scenarios, the user may be charged for the code or codes he or she desired (determination 156). Consequently, the user may submit payment, for example, over the internet or by credit card over the phone, to obtain desired codes.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A display device comprising:
a user input device for allowing a user to input a predetermined code; and
a processor programmed to automatically adjust one or more image optimization settings of said display device based on said predetermined code.

2. The display device of claim 1, wherein said predetermined code consists of an alphanumeric string.

3. The display device of claim 2, wherein said predetermined code consists of a numeric string.

4. The display device of claim 1, further comprising a memory unit for storing said predetermined code.

5. The display device of claim 1, wherein said predetermined code specifies one or more settings for said display device based on ambient conditions in which said display device is used.

6. The display device of claim 5, wherein said ambient conditions comprise an ambient light level.

7. The display device of claim 5, wherein said ambient conditions comprise an ambient light type.

8. The display device of claim 1, wherein said predetermined code specifies one or more settings for said display device based on a source of a video signal input to said display device.

9. The display device of claim 1, wherein said predetermined code specifies one or more settings for said display device based on a type of video signal input to said display device.

10. The display device of claim 1, wherein said predetermined code specifies one or more settings for said display device based on a content of a video signal input to said display device.

11. The display device of claim 1, wherein programming for said processor is stored in a memory unit of said display device, wherein said programming, when executed by said processor, interprets said predetermined code and implements setting adjustments specified by said predetermined code.

12. The display device of claim 1, further comprising a video display with controllable display components operated according to said settings.

13. The display device of claim 1, wherein said display device comprises a projector.

14. The display device of claim 1, wherein said display device comprises a video monitor.

15. The display device of claim 1, wherein said user input device comprises a user input device on said display device.

16. The display device of claim 1, wherein said user input device comprises a remote control unit configured to communicate with said display device.

17. A method of operating a display device comprising inputting a predetermined code using a user input device of said display device that causes said display device to automatically adjust one or more image optimization settings of said display device based on said predetermined code.

18. The method of claim 17, wherein said predetermined code consists of an alphanumeric string.

19. The method of claim 18, wherein said predetermined code consists of a numeric string.

20. The method of claim 17, further comprising storing said predetermined code in a memory of said display device.

21. The method of claim 20, further comprising retrieving a stored code and adjusting one or more settings of said display device based on said stored code.

22. The method of claim 17, wherein said predetermined code specifies one or more settings for said display device based on ambient conditions in which said display device is used.

23. The method of claim 22, wherein said ambient conditions comprise an ambient light level.

24. The method of claim 17, wherein said predetermined code specifies one or more settings for said display device based on a source of a video signal input to said display device.

25. The method of claim 24, wherein said predetermined code specifies one or more settings for said display device based on said display device receiving a video signal from a video game system.

26. The method of claim 17, wherein said predetermined code specifies one or more settings for said display device based on a content of a video signal input to said display device.

27. The method of claim 17, wherein said adjustment to one or more settings of said display device is performed a programmed processor that interprets said predetermined code and implements setting adjustments specified by said predetermined code.

28. A display device comprising:
means for inputting a predetermined code; and
means for automatically adjusting one or more image optimization settings of said display device based on said predetermined code.

29. The display device of claim 28, wherein said predetermined code consists of an alphanumeric string.

30. The display device of claim 29, wherein said predetermined code consists of a numeric string.

31. The display device of claim 28, further comprising means for storing said predetermined code in said display device.

32. The display device of claim 28, wherein said predetermined code specifies one or more settings for said display device based on ambient conditions in which said display device is used.

33. The display device of claim 32, wherein said ambient conditions comprise an ambient light level.

34. The display device of claim 28, wherein said predetermined code specifies one or more settings for said display device based on a source of a video signal input to said display device.

35. The display device of claim 34, wherein said predetermined code specifies one or more settings for said display device based on said display device receiving a video signal from a video game system.

36. The display device of claim 28, wherein said predetermined code specifies one or more settings for said display device based on a content of a video signal input to said display device.

37. The display device of claim 28, wherein said means for automatically adjusting said one or more settings of said display device comprise programming for a processor that is stored in a memory unit of said display device, wherein said programming, when executed by said processor, interprets said predetermined code and implements setting adjustments specified by said predetermined code.

38. The display device of claim 28, further comprising means for displaying an image, said means for displaying an image comprising controllable display components operated according to said settings.

39. The display device of claim 28, wherein said display device comprises a projector.

40. The display device of claim 28, wherein said display device comprises a video monitor.

41. The display device of claim 28, wherein said means for inputting a predetermined code comprise a user input device on said display device.

42. The display device of claim 28, wherein said means for inputting a predetermined code comprise a remote control unit configured to communicate with said display device.

43. A method of supporting operation of a display device, said method comprising:
generating a predetermined code that specifies image optimization settings for said display device based on particular operating circumstances; and
distributing said predetermined code to users of said display device.

44. The method of claim 43, wherein said distributing comprises posting said predetermined code on the Internet.

45. The method of claim 43, wherein said distributing comprises sending said predetermined code in an email.

46. The method of claim 43, wherein said distributing comprising sending said predetermined code by mail.

47. The method of claim 43, wherein said distributing comprising distributing said predetermined code by phone.

48. The method of claim 43, wherein said distributing comprising publishing said predetermined code in print.

49. The method of claim 43, further comprising charging a fee for said predetermined code.

50. The method of claim 43, wherein said predetermined code consists of an alphanumeric string.

51. The method of claim 50, wherein said predetermined code consists of a numeric string.

52. The method of claim 43, wherein said predetermined code specifies one or more settings for said display device based on ambient conditions in which said display device is used.

53. The method of claim 52, wherein said ambient conditions comprise an ambient light level.

54. The method of claim 43, wherein said predetermined code specifies one or more settings for said display device based on a source of a video signal input to said display device.

55. The method of claim 54, wherein said predetermined code specifies one or more settings for said display device based on said display device receiving a video signal from a video game system.

56. The method of claim 43, wherein said predetermined code specifies one or more settings for said display device based on a content of a video signal input to said display device.
